(19) United States
(12) Patent Application Publication
(10) Pub. No.: US 2014/0168186 A1
(43) Pub. Date: Jun. 19, 2014

(54) DISPLAY DEVICE AND METHOD OF DRIVING THE SAME

(71) Applicant: SAMSUNG DISPLAY CO., LTD., Yongin-City (KR)

(72) Inventors: Kyungwon KANG, Cheonan-si (KR); Young-Sun KWAK, Cheonan-si (KR)

(73) Assignee: Samsung Display Co., Ltd., Yongin-City (KR)

(21) Appl. No.: 13/862,232

(22) Filed: Apr. 12, 2013

(30) Foreign Application Priority Data
Dec. 13, 2012 (KR) 10-2012-0145625

(51) Int. Cl. G09G 5/00

(52) U.S. Cl. CPC G09G 5/00
USPC 345/212

(57) ABSTRACT

A display device includes a display panel including gate lines, data lines, and pixels connected to the gate lines and the data lines, a gate driver driving the gate lines, a data driver driving the data lines, a voltage generator generating first and second voltages to drive the gate driver, and a timing controller receiving an image signal, applying a data signal and first control signals to the data driver, and applying second control signals to the gate driver. The timing controller calculates a total operation time of the display panel and applies a first voltage control signal and a second voltage control signal to the voltage generator to correspondingly change a voltage level of at least one of the first and second voltages when the total operation time exceeds a predetermined reference time.

### CROSS-REFERENCE TO RELATED APPLICATION

This application claims priority under 35 U.S.C. §119 to Korean Patent Application No. 10-2012-0145625, filed on Dec. 13, 2012, the disclosure of which is incorporated by reference herein in its entirety.

### BACKGROUND

1. Field of disclosure

The present disclosure of invention relates to a display device and a method of driving the display device.

2. Description of Related Technology

In recent years, image displaying devices have been applied to various electronic apparatuses, e.g., personal computers, television sets, airport or other destination guiding apparatuses, commercial display apparatuses, transfer ticket dispensing machines, etc. Particularly, when the display device is used as an outdoor public display device in for example, commercial settings, the display device tends to become large. Additionally, such outdoor and/or public and/or commercial use display devices tend to be operated for longer durations than those of private-use indoor display devices such as those used in offices and at home. Moreover, such outdoor and/or public and/or commercial use display devices tend to be operated such that they continuously display one or more specific images.

In general, the large sized commercial-use display device includes pixels each including a switching transistor to control on and off operations thereof The switching transistor is deemed to be turned on in response to application of a gate-on voltage having a predetermined voltage level (V_{gON}) and deemed to be turned off in response to application of a gate-off voltage having a predetermined voltage level (V_{gOFF}).

Because the outdoor and/or public and/or commercial use display device tends to be subjected to widely varying conditions (e.g., temperature, aging, etc.) and because the characteristics of the switching transistors can change substantially as a function of the operation time of the display device, of its temperature and so on; the current leakage levels of the transistors at fixed turn-on and turn-off voltage levels can become varied. In this case, an undesired stain, such as a black mura, may occur on the screen of the display device.

It is to be understood that this background of the technology section is intended to provide useful background for understanding the here disclosed technology and as such, the technology background section may include ideas, concepts or recognitions that were not part of what was known or appreciated by those skilled in the pertinent art prior to corresponding invention dates of subject matter disclosed herein.

### SUMMARY

The present disclosure of invention provides a display device capable of preventing a display quality from degrading even though a total operation time of the display device becomes relatively long and transistor characteristics shift as a result.

An exemplary embodiment provides a display device including a display panel that includes a plurality of gate lines, a plurality of data lines, and a plurality of pixels each being connected to a corresponding gate line of the gate lines and a corresponding data line of the data lines, a gate driver that drives the gate lines, a data driver that drives the data lines, a voltage generator that generates a first voltage and a second voltage to drive the gate driver, and a timing controller that receives an image signal, applies a data signal and first control signals to the data driver, and applies second control signals to the gate driver. The timing controller calculates a total operation time of the display panel and applies a first voltage control signal and a second voltage control signal to the voltage generator to thereby change a voltage level of at least one of the first and second voltages when the total operation time exceeds a predetermined reference time.

The timing controller further includes a memory to store the predetermined reference time (RCNT), an accumulated driving time (ACNT), a reference first voltage control signal (RVH) corresponding to the first voltage, and a reference second voltage signal (RVL) corresponding to the second voltage.

The voltage control signal generator reads out from the memory and at least when a power is turned on for the display device, the predetermined reference time, the accumulated driving time, the reference first voltage signal, and the reference second voltage signal.

The timing controller further includes a counter to count a number of pulses of a supplied synchronization signal from an external device, and the total operation time corresponds to a sum of the accumulated driving time and a time corresponding to the count value of the counter.

The voltage control signal generator reads out the first and second voltage control signals corresponding to the total operation time from the memory at least when the total operation time exceeds the predetermined reference time, and applies the first and second voltage control signals respectively to the voltage generator in correspondence with the first and second voltage level signals.

The voltage generator generates the first voltage having the voltage level corresponding to the first voltage control signal and the second voltage having the voltage level corresponding to the second voltage control signal.

The voltage generator stores the total operation time in the memory as the accumulated driving time when the total operation time exceeds the predetermined reference time.

The counter counts a number of pulses of at least one of a vertical synchronization signal, a horizontal synchronization signal, an image data enable signal, and a main clock signal.

The display device further includes a counter that counts a period of a synchronization signal from an external device and a memory that stores the reference time, an accumulated driving time, a first voltage signal corresponding to the first voltage, and a second voltage signal corresponding to the second voltage.

The timing controller reads out the reference time, the accumulated driving time, the first voltage signal, and the second voltage signal from the memory when a power is turned on.

The total operation time (TCNT) corresponds to a sum of the accumulated driving time and a time corresponding to the count value of the counter.

A method of driving a display device includes setting initial voltage levels of a gate on voltage and a gate off voltage when a power is turned on, counting a number of pulses of a synchronization signal to calculate a total operation time of the display device, and changing a voltage level of at least one of the gate on voltage and the gate off voltage when the total operation time exceeds a predetermined reference time.

The setting of the initial voltage level includes reading out the reference time, an accumulated driving time, a first voltage signal, and a second voltage signal from a memory and outputting the gate on voltage having the voltage level corresponding to the first voltage signal and the gate off voltage having the voltage level corresponding to the second voltage signal.

The total operation time corresponds to a sum of the accumulated driving time and a time corresponding to a count value obtained by counting the period of the synchronization signal.

The changing of the voltage level of the gate on voltage and the gate off voltage includes reading out the first and second voltage signals corresponding to the total operation time from the memory when the total operation time exceeds the reference time, outputting a gate on voltage control signal corresponding to the first voltage signal and a gate off voltage control signal corresponding to the second voltage signal, and outputting the gate on voltage having the voltage level corresponding to the gate on voltage control signal and the gate off voltage having the voltage level corresponding to the gate off voltage control signal.

The memory stores a plurality of reference times, a plurality of first voltage signals respectively corresponding to the reference times, and a plurality of second voltage signals respectively corresponding to the reference times.

The method further includes storing the updated total operation time in the memory as the new accumulated driving time when the updated total operation time exceeds the predetermined reference time and reading out a new reference time corresponding to the new accumulated driving time from the memory.

According to the above, although the operation time of the display device becomes longer than the reference time, the display quality of the display device may be prevented from being deteriorated since the voltage level of the turn-on and off voltage of the switching transistor is changed to compensate for shifting characteristics of the switching transistor as its total operation time increases.

### BRIEF DESCRIPTION OF THE DRAWINGS

The above and other advantages of the present disclosure will become readily apparent by reference to the following detailed description when considered in conjunction with the accompanying drawings wherein:

FIG. 1 is a block diagram showing a display device according to an exemplary embodiment of the present disclosure;

FIG. 2 is a graph showing a time-dependent variation of characteristics of a switching transistor in a pixel such as shown in FIG. 1;

FIG. 3 is a block diagram showing further details of a timing controller shown in FIG. 1;

FIG. 4 is a graph showing a variation of a level of a gate on voltage generated by a voltage generator shown in FIG. 1, which variation of the applied VgON level is controlled by the timing controller of FIG. 3;

FIG. 5 is a block diagram showing a display device according to another exemplary embodiment;

FIG. 6 is a flowchart showing a method of driving a display device according to an exemplary embodiment; and

FIG. 7 is a block diagram showing a display device according to another exemplary embodiment.

### DETAILED DESCRIPTION

Hereinafter, exemplary embodiments of the present disclosure of invention will be described in detail with reference to the accompanying drawings.

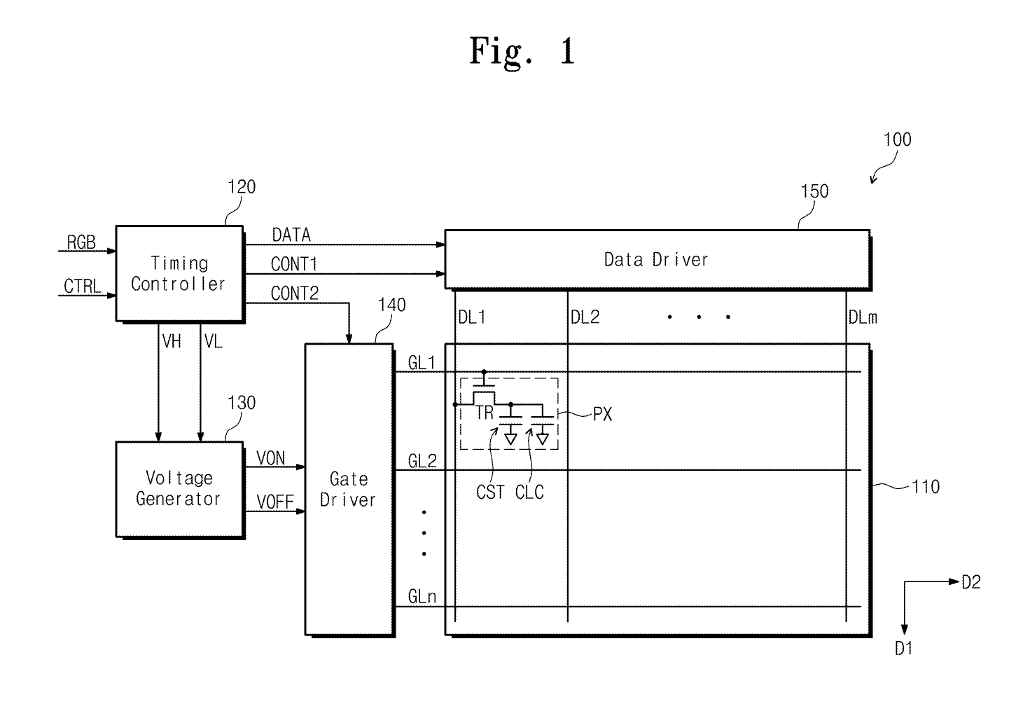

FIG. 1 is a block diagram showing a display device according to an exemplary embodiment of the present disclosure.

Referring to FIG. 1, the display device 100 includes a display panel 110, a timing controller 120, a voltage generator 130, a gate driver 140, and a data driver 150. While not shown, the display device 100 is understood to be connected to (or connectable to) a power supply that can deliver one or more voltage supply voltages to the display device 100 for use when the display device 100 is in operation; where one or more of such voltage supply voltages may be turned off when the display device 100 is not in operation. Additionally, and while not shown, the display device 100 may include (or may be configured to operatively couple with) a backlighting unit that supplies backlighting to the panel portion 110 of the display device 100.

The display panel 110 includes a plurality of data lines DL1 to DLm extended in a first direction D1, a plurality of gate lines GL1 to GLn extended in a second direction D2 to cross the data lines DL1 to DLm, and a plurality of pixel units PX arranged in respective pixel areas defined by the areas between the data lines DL1 to DLm and the gate lines GL1 to GLn. The data lines DL1 to DLm are insulated from the gate lines GL1 to GLn.

Each pixel unit PX includes at least one switching transistor TR connected to a corresponding data line among the data lines DL1 to DLm and a corresponding gate line among the gate lines GL1 to GLn. Each pixel unit PX additionally includes a liquid crystal capacitor CLC connected to the switching transistor TR, and a charge storage capacitor CST connected to the switching transistor TR.

The pixel units PX may have substantially same structures one to the next (except that colors of respective color filters may differ), and thus only one pixel unit will be described in detail as a representative example. The switching transistor TR of the pixel unit PX includes a gate electrode connected to a corresponding first gate line GL1, a source electrode connected to a corresponding first data line DL1, and a drain electrode connected to a corresponding liquid crystal capacitor CLC and a corresponding storage capacitor CST. A first terminal of the liquid crystal capacitor CLC and of the storage capacitor CST is connected to the drain electrode of the switching transistor TR. The opposed and respective second terminals of the liquid crystal capacitor CLC and of the storage capacitor CST may be both connected to a common voltage (Vcom) although in other embodiments the opposed second terminal of the storage capacitor CST may be connected to a switchable node that has a different voltage level than Vcom. The switching transistor TR may be a thin film transistor having a semiconductor or a semiconductive oxide layer as an active layer thereof.

The timing controller 120 receives image signals such as RGB color defining signals and control signals CTRL, e.g., a vertical synchronization signal, a horizontal synchronization signal, a main clock signal, a data enable signal, etc., from an external device (not shown). The timing controller 120 processes the image signals RGB appropriate to an operation condition of the display panel 110 on the basis of the control signals CTRL and outputs corresponding data signals DATA. The timing controller 120 applies the data signals DATA and a first control signal CONT1 to the data driver 150 and applies a second control signal CONT2 to the gate driver 140. The first control signal CONT1 includes a horizontal synchronization start signal, a clock signal, and a line latch signal and the second control signal CONT2 includes a vertical synchronization start signal, an output enable signal, and a gate pulse signal. In one embodiment, at least one of the control signals CTRL (e.g., a vertical synchronization start signal) is not applied to the timing controller 120 from an outside source (e.g., a controlling data processing unit not shown) when the display device 100 is not in a full and continuous operation mode.

The data driver 150 outputs gray-scale voltages in response to the data signals DATA and the first control signal CONT1 from the timing controller 520 to drive the data lines DL1 to DLm.

The voltage generator 130 generates respective gate on voltages VON and gate off voltages VOFF optionally in response to the CTRL signal indicating that such are currently desired and non-optionally in variable-level response to a first voltage control signal VH and a second voltage control signal VL supplied to the voltage generator 130 from the timing controller 120.

The gate driver 140 drives the gate lines GL1 to GLn in response to the second control signal CONT2 from the timing controller 120 and the gate on and off voltages VON and VOFF from the voltage generator 130. The gate driver 140 includes one or more gate driver integrated circuits.

When a gate on voltage VON is applied to one gate line, switching transistors arranged in one row and connected to the one gate line are turned on. In this case, the data driver 150 provides the gray-scale voltages corresponding to the turned on row and in accordance with the data signal DATA onto the data lines DL1 to DLm. The gray-scale voltages applied to the data lines DL1 to DLm are applied to corresponding pixels through the turned-on switching transistors.

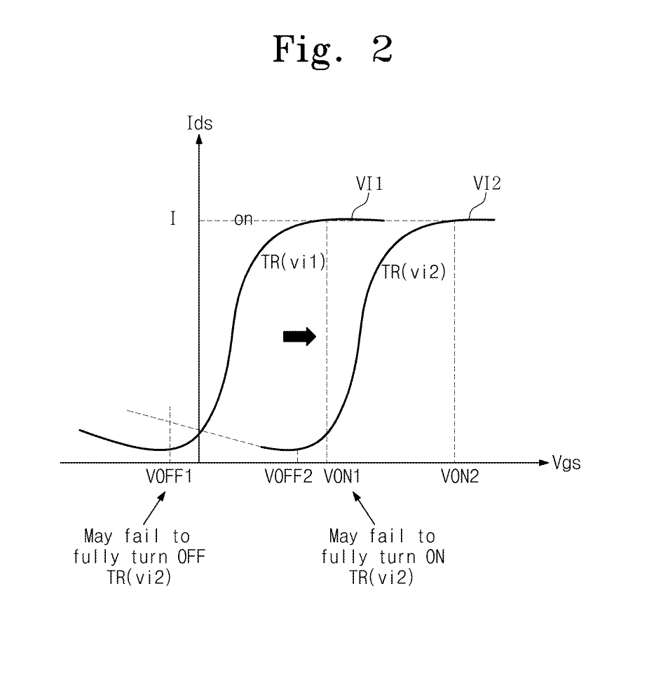

FIG. 2 is a graph showing a variation of characteristics of a switching transistor in a pixel unit such as shown in FIG. 1 as a function of time of operation.

Referring to FIGS. 1 and 2, each of first and second curves VI1 and VI2 represents a gate voltage to drain-source current (Vgs/Ids) characteristic of the switching transistor TR in the pixel unit PX. The voltage Vgs represents a voltage between the gate electrode and the source electrode of the switching transistor TR and the current Ids represents a current between the drain electrode and the source electrode of the switching transistor TR for a predetermined drain to source loading circuit (not shown).

The first curve VI1 represents the voltage-current characteristic of a switching transistor TR(vi1) in a sample pixel unit PX when the display device 100 is initially turned on and operated by a user after being manufactured for less than a reference length of time (e.g., <<3500 Hours). The second curve VI2 represents the voltage-current characteristic of a switching transistor TR(vi2) in a sample pixel unit PX after the display device 100 is operated in terms of total operating time for a duration equal to or greater than a predetermined time period, e.g., about 3500 hours.

The turn-on voltage for fully turning on the switching transistor TR(vi1) in the sample pixel unit PX is at a first turn-on level VON1 when the display device 100 is initially operated for substantially less than the reference length of time. However, the turn-on voltage for fully turning on the switching transistor TR(vi2) in the sample pixel unit PX is increased to a second turn-on level VON2 higher than the first turn-on voltage VON1 after the predetermined, post-manufacture operation time (e.g., 3500 total hours) has lapsed.

In addition, the turn-off voltage for fully turning off (minimal Ids leakage current) the switching transistor TR(vi1) in the sample pixel unit PX is at a first turn-off level VOFF1 when the display device 100 is initially operated for substantially less than the reference length of time. However, the turn-off voltage for fully turning off (minimal Ids leakage current) the switching transistor TR(vi2) in the sample pixel unit PX is increased to a second turn-off level VOFF2 higher than the first turn-off voltage VOFF1 after the predetermined, post-manufacture operation time (e.g., 3500 total hours) has lapsed.

When the voltage(Vgs)-current(Ids) characteristic changes like this according to the lapse of total operation time, the switching transistor TR(viN) {where N can be 1 or 2 or somewhere in between} may fail to be fully turned on (to a desired maximum Ids level) even though the gate on voltage having the first turn-on level VON1 is applied to the gate electrode of the switching transistor TR(viN) through its corresponding gate line. Similarly, although the gate off voltage having the first turn-off level VOFF1 is applied to the gate electrode of the switching transistor TR(ivN) through its gate line, that switching transistor TR(ivN) may fail to turn off to the extent desired (e.g., it may have an undesirably large leakage I_{DS}). In particular, as represented by the second curve VI2, when a difference between the first turn-on level VON1 and the second turn-on level VON2 is large, the corresponding switching transistor TR(ivN) of the respective pixel unit PX becomes difficult to fully turn on (e.g., to attain its minimal drain/source resistance Rds). Therefore, at least for those of the switching transistors, in which their Vgs/Ids characteristics are degraded due to aging from operating longer than a predetermined time duration after initial manufacture, these degraded transistors TR(ivN, for N>1) can be maintained in a turned-off state rather than a then-desired, ON state, and as a result, a black mura phenomenon, in which a portion of the display panel 110 continuously displays a black image, undesirably occurs.

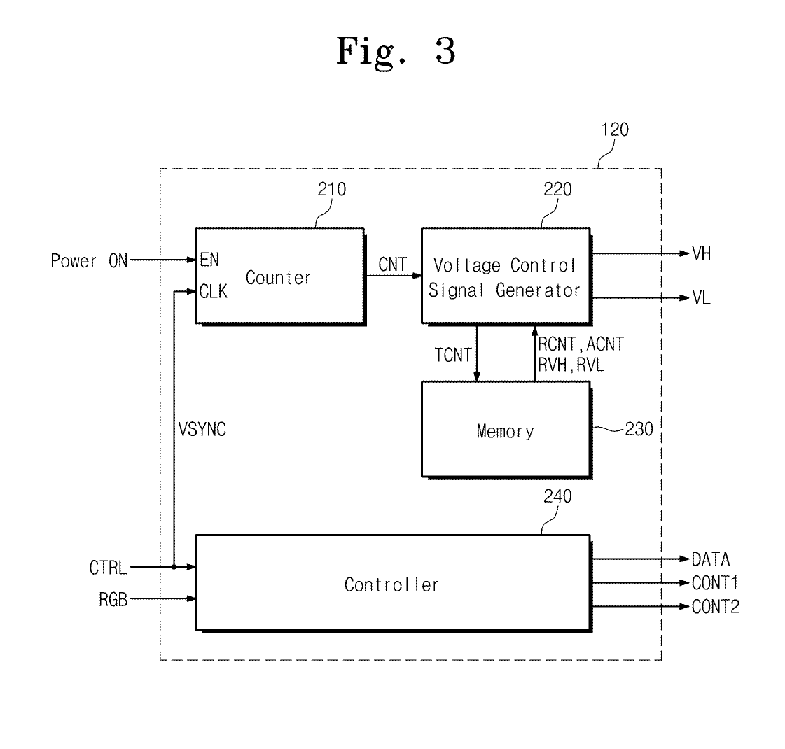

FIG. 3 is a block diagram showing a timing controller usable in FIG. 1.

Referring to FIGS. 1 and 3, the timing controller 120 includes a digital counter 210, a voltage control signal generator 220, a memory 230, and a display controller 240. The counter 210 receives and is responsive to at least one of the control signals CTRL to thereby count the latest, turned-on operation time of the display panel 110 after power is turned on (signaled by a PowerON indicator signal). As an example, the counter 210 counts the operation time of the display panel 110 in terms of total number of frames displayed by using the vertical synchronization signal VSYNC among the control signals CTRL as the clock input to the counter. (PowerON may go to the counter enable terminal EN while PowerON_NOT may go to the counter reset terminal RST, (not shown) such that the counter 210 is reset and starts counting up from zero when PowerON is asserted.) That is, the counter 210 counts the number of times the vertical synchronization signal VSYNC is asserted after PowerON is asserted and outputs a digital count value signal CNT representing the number of frames displayed since the power-on indicator signal PowerON is asserted to indicate the display is operating. In FIG. 3, the counter 210 counts the number of frames by using the vertical synchronization signal VSYNC, but it should not be limited thereto or thereby. For instance, the counter 210 may instead count the number of horizontal synchronization signals asserted, or the pulses of the main clock signal (not shown; or the latter divided down by a predetermined divisor value), or the number of times an RGB data enable signal is asserted. When power is turned off, the count value CNT output from the counter 210 may be reset (RST) to zero (0). The display controller 240 receives the image signals RGB and the control signals CTRL, such as, the vertical synchronization signal, the horizontal synchronization signal, the main clock signal, the RGB data enable signal, etc., from the external device (not shown). The controller 240 processes the image signals RGB as appropriate to the operation condition of the display panel 110 on the basis of the control signals CTRL and outputs the corresponding digital data signal DATA, the first control signal CONT1, and the second control signal CONT2.

The voltage control signal generator 220 outputs a gate-on voltage control signal VH and a gate-off voltage control signal VL in response to the most recent count value CNT as well as in response to a previously accumulated (and stored) count value ACNT. The sum of CNT and ACNT is used to produce a current total count signal TCNT. When the count value CNT is at zero while the power is being turned on, the voltage control signal generator 220 reads out from the memory 230, a reference time duration value RCNT, the previous accumulated driving time value ACNT, a first voltage signal value RVH, and a second voltage signal value RVL, where the latter may correspond to the TCNT signal which represents the sum of the current count value CNT and the previously accumulated (and stored) count value ACNT.

In response to the sum of the current count value CNT and the previously accumulated (and stored) count value ACNT—which sum is denoted as a calculated total count signal TCNT—the voltage control signal generator 220 outputs a corresponding gate-on voltage control signal VH corresponding to the read-out first voltage reference signal RVH and the gate-off voltage control signal VL corresponding to the read-out second voltage reference signal RVL. Although not shown, it is to be understood that memory 230 may be programmed to include a lookup table (LUT) that receives the total count signal TCNT as an input and outputs in response at least one of the RHV, RHL and RCNT signals.

The count value CNT of the counter 210 is increased while the display device 100 is operated, i.e., while the vertical synchronization signal VSYNC is repeatedly reasserted for each displayed frame. The voltage control signal generator 220 adds the count value CNT and the accumulated driving time ACNT read out from the memory 230 to calculate the total driving time TCNT. The voltage control signal generator 220 internally compares the total driving time TCNT with the most recent reference time duration RCNT value read out from the memory 230. While the driving time TCNT does not exceed the reference time duration value RCNT, the voltage control signal generator 220 maintains the current gate-on voltage control signal VH and the current gate-off voltage control signal VL.

When the driving time TCNT is determined to exceed the reference time duration value RCNT in accordance with the increase of the latest real-time count value CNT, the voltage control signal generator 220 reads out from the memory 230 a new (next) reference time display device RCNT, a new first voltage signal RVH, and a new second voltage signal RVL, which correspond to the new total driving time TCNT. In addition, the voltage control signal generator 220 stores the new total driving time TCNT in the memory 230 as the accumulated driving time ACNT to be read out the next time.

The voltage control signal generator 220 outputs the gate-on voltage control signal VH corresponding to the first voltage reference signal RVH read out from the memory 230 and the gate-off voltage control signal VL corresponding to the second voltage reference signal RVL read out from the memory 230, where optionally the latter RVH and RVL signals may further be functions of the latest CNT value. The voltage control signal generator 220 continuously performs the operation of comparing the new reference time RCNT and the driving time TCNT, so as to determine when next to update the values stored in and read out from the memory 230.

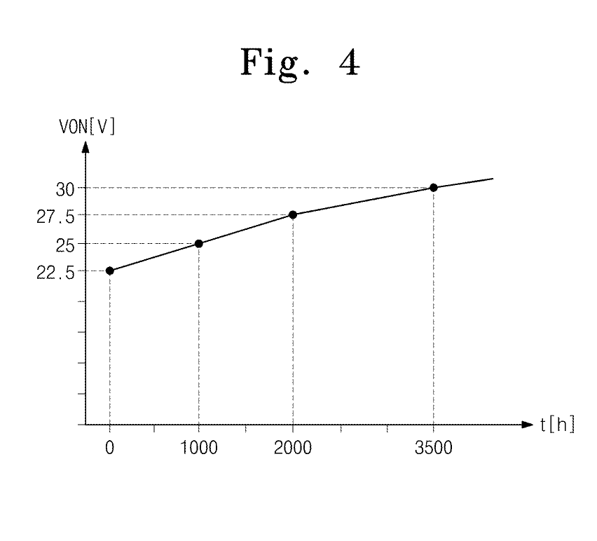

FIG. 4 is an example graph showing a variation over time (t in hours) of the level of the gate-on voltage generated by the voltage generator shown in FIG. 1, which variation is caused by the control of the timing controller shown in FIG. 3. FIG. 4 shows only the variation of the level of the gate-on voltage (V_{Gon}), but it is to be understood that the variation of the level of the gate-off voltage (V_{Goff}) can be varied as a function of accumulated operation time in a substantially same manner as that illustrated for the gate-on voltage in FIG. 4.

Referring to FIGS. 1, 3, and 4, when the power is turned on for substantially the first time that the display device is in the field for operational use (after manufacture), the count value CNT of the counter 210 of the timing controller 120 is zero. The voltage control signal generator 220 reads out the reference time RCNT, the accumulated driving time ACNT, the first voltage signal RVH, and the second voltage signal RVL, which correspond to the count value CNT, from the memory 230. The accumulated driving time ACNT is zero in this example of first operation after manufacture, and by way of example the reference time RCNT for when the ACNT will be updated is when TCNT is about 1000 hours. In this example, the initially read-out first voltage signal RVH corresponds to a gate-on voltage (V_{Gon}) of about 22.5 volts.

After more than 1000 hours of operational time has elapsed and ACNT is updated to reflect this, the voltage control signal generator 220 outputs the gate on voltage control signal VH in response to the first voltage signal RVH to allow the gate on voltage VON to have an increased voltage level of about 25 volts. The voltage generator 130 generates the gate on voltage VON of about 25 volts in response to the gate on voltage control signal VH at that time.

When the driving time TCNT obtained by summing the count value CNT and the accumulated driving time ACNT exceeds the reference time RCNT of about 2000 hours, which latter value is read out from the memory 230, the voltage control signal generator 220 reads out the next to be used, reference time RCNT, the first voltage signal RVH, and the second voltage signal RVL from the memory 230, which correspond to the total driving time TCNT of 2000 hours. As seen in FIG. 4, when the total count TCNT crosses above the reference time RCNT of about 2000 hours, the first voltage signal RVH is increased to correspond to a gate-on voltage (V_{Gon}) of about 27.5 volts, which is newly read out from the memory 230.

Accordingly, the voltage control signal generator 220 outputs the gate on voltage control signal VH in response to the first voltage signal RVH to allow the gate on voltage VON to have a voltage level of about 27.5 volts and proportionally higher as TCNT climbs beyond 2000 hours. The voltage generator 130 generates the gate on voltage VON of about 27.5 volts and proportionally higher in response to the gate on voltage control signal VH read out from memory and in response to the continuously growing value of the total count TCNT.

When the driving time TCNT exceeds the reference time RCNT of about 3000 hours, which is read out from the memory 230, the voltage control signal generator 220 reads out the reference time RCNT, the first voltage signal RVH, and the second voltage signal RVL from the memory 230, which correspond to the latest total count value TCNT. At this stage of device aging, the reference time RCNT is about 3500 hours and the first voltage signal RVH corresponds to about 30 volts, which data are newly read out from the memory 230.

The voltage control signal generator 220 outputs the gate on voltage control signal VH in response to the first voltage signal RVH such that the gate on voltage VON has a voltage level of about 30 volts or proportionally higher as the latest total count value TCNT ages even more. The voltage generator 130 generates the gate on voltage VON of about 30 volts in response to the gate on voltage control signal VH.

As described above, the voltage level of the gate on voltage VON may be changed in accordance with the total operation time of the display device 100 so as to reflect the changing characteristics of the switching transistors TR as a function of total operational time.

Table 1, following below, shows an example of the gate on voltage VON and the gate off voltage VOFF to be generated for one embodiment by the voltage generator 130 according to the reference time RCNT stored in the memory 230 of the timing controller 120 shown in FIG. 1.

TABLE 1

| Reference | Gate on | Gate off |
|---|---|---|
| time (RCNT) | voltage (VON) | voltage (VOFF) |
| 0 hour | 22.5 volts | −4 volts |
| 1000 hours | 25 volts | −1.5 volts |
| 2000 hours | 27.5 volts | 2.5 volts |
| 3500 hours | 30 volts | 6.5 volts |
| 5000 hours | 32 volts | 8.5 volts |

As shown in Table. 1, as the accumulated operation time of the display device 100 becomes longer and longer, the gate on voltage VON and the gate off voltage VOFF generated by the voltage generator 130 are gradually increased. The degree of increase may be computed on a linear progressive basis using the sample reference points provided by the data in the memory 230 and/or other interpolation schemes may be used that involve nonlinear connecting curves (between the stored sample points) as may be appropriate in respective applications.

The display device 100 gradually increases the gate on voltage VON and the gate off voltage VOFF, and thus the display device 100 may prevent the display quality from being deteriorated due to degradation of characteristic of the switching transistors TR in the respective pixel unit PX as the display device ages due to in-field operation. Furthermore, since the gate on voltage VON and the gate off voltage VOFF are increased step by step according to the operation time of the display device 100 so as to provide a relatively minimal Rds when the transistor TR is intended to be on and so as to provide a relatively maximum Rds when the transistor TR is intended to be off, a lifetime power consumption of the display device 100 may be reduced.

The variation amount of the voltage level of the gate on voltage VON and the gate off voltage VOFF according to the operation time of the display device 100 may be stored in the memory 230 when the display device 100 is manufactured. In addition, in embodiments where the memory 230 is a reprogrammable nonvolatile one, even if the originally programmed in values do not work as expected and the display quality of the display device 100 deteriorates by the black mura phenomenon while the display device 100 is used by a user (e.g., one who telephones in to complain), the reprogrammable nonvolatile memory 230 may be appropriately reprogrammed in response and the display quality of the display device 100 may be improved by changing the first voltage signal RVH and the second voltage signal RVL, which are stored in the memory 230 for current and future accumulated operation times of the device.

In one embodiment, the memory 230 is a nonvolatile static storage device, such as an erasable and re-programmable read-only memory (EPROM), an electrically erasable and re-programmable read-only memory (EEPROM), a flash memory, a battery backed-up random access memory (RAM), a read only memory (ROM), etc.

In the present exemplary embodiment, both of the gate on voltage VON and the gate off voltage VOFF are changed, but they should not be limited thereto or thereby. That is, only one of the gate on voltage VON and the gate off voltage VOFF may be changed in response to the crossing beyond a next of successive RCNT values. According to one set of embodiments, the gate on voltage VON and the gate off voltage VOFF are alternately changed. In other words, the gate off voltage VOFF is increased only after the gate on voltage VON has been increased, or the gate on voltage VON is increased only after the gate off voltage VOFF has been increased. That is, the gate on voltage VON and the gate off voltage VOFF may be changed in various orders depending on how these characteristics of the switching transistor TR change as a function of accumulated operation time. It is to be understood that the switching transistor TR may be formed using different transistor technologies including, but not limited to, polycrystalline silicon technology, amorphous silicon technology, and semiconductive oxide technologies. Each may have respective and different aging properties in response to accumulated operation time.

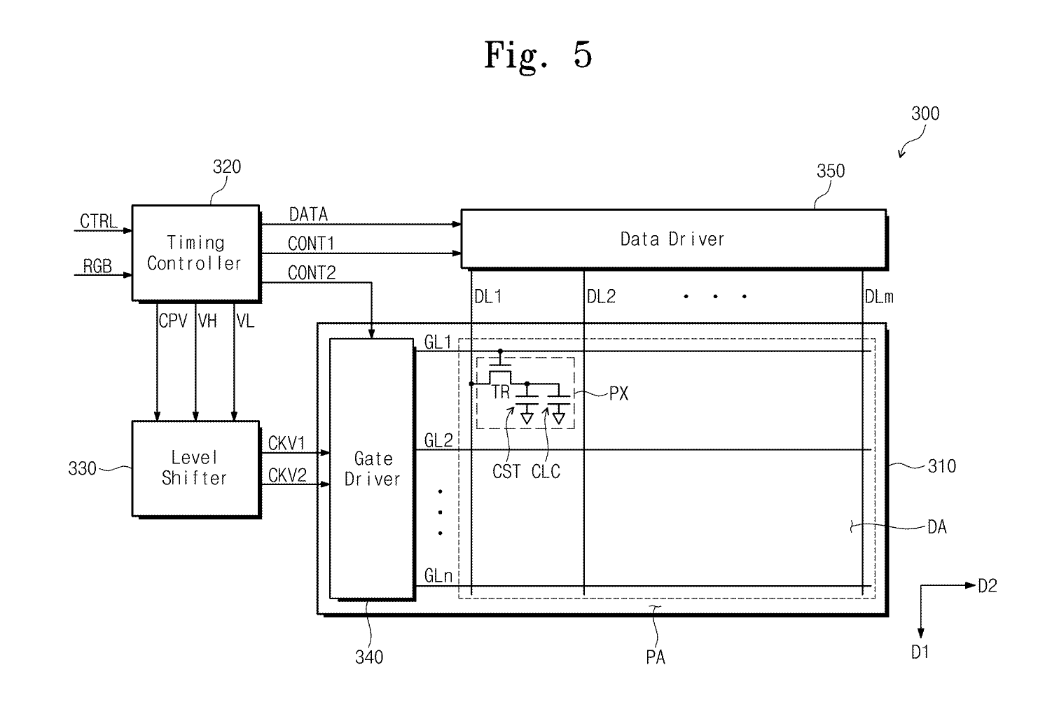

FIG. 5 is a block diagram showing a display device according to another exemplary embodiment of the present disclosure.

Referring to FIG. 5, a display device 300 includes a display panel 310, a timing controller 320, a level shifter 330, a gate driver 340, and a data driver 350. Different from the display device 100 including the voltage generator 120 as shown in FIG. 1, the display device 300 shown in FIG. 5 includes a combination level shifter and clocks generator 330. The timing controller 320 applies not only the gate on voltage control signal VH and the gate off voltage control signal VL but also a gate pulse signal CPV to the combination level shifter and clocks generator 330.

Is response, the combination level shifter and clocks generator 330 generates a first gate clock signal CKV1 and a second gate clock signal CKV2 in synchronized response to the gate pulse signal CPV, where the CKV1 and CKV2 gate clock signals have respective low and high levels corresponding to the gate on voltage control signal VH, and the gate off voltage control signal VL. In other words, a high level of each of the first and second clock signals CKV1 and CKV2 is set to a voltage level corresponding to the gate on voltage control signal VH and a low level of each of the first and second clock signals CKV1 and CKV2 is set to a voltage level corresponding to the gate off voltage control signal VL. Therefore, the voltage level of the first and second gate clock signals CKV1 and CKV2 may be changed in accordance with the operation time of the display device 300.

The display panel 310 includes a display area DA and a peripheral area PA. The gate lines GL1 to GLn and the data lines DL1 to DLm are arranged in the display area DA, and thus pixel areas are defined in a matrix form by the gate lines GL1 to GLn and the data lines DL1 to DLm. The pixel PX configured to include the thin film transistor TR, the liquid crystal capacitor CLC, and the storage capacitor CST is disposed in each pixel area.

The gate driver 340 is disposed in the peripheral area PA of the display panel 310 to be adjacent to a side of the display area DA. In respective embodiments, the gate driver 340 may be configured as a monolithically integrated part of the panel using an appropriate one of amorphous silicon gate thin film transistor (a-Si TFT) technology, semiconductive oxide technology or, crystalline semiconductor, or polycrystalline semiconductor technology. The gate driver 340 drives the gate lines GL1 to GLn in response to the second control signal CONT2 from the timing controller 320 and the first and second gate clock signals CKV1 and CKV2 from the combination level shifter and clocks generator 330.

As the operation time of the display device 300 becomes long, the high level and the low level of the first and second gate clock signals CKV1 and CKV2 are gradually increased. Therefore, the switching transistors TR may be normally turned on or off even though the voltage-current (Vgs-Ids) characteristic of the switching transistor TR in the pixel PX is changed.

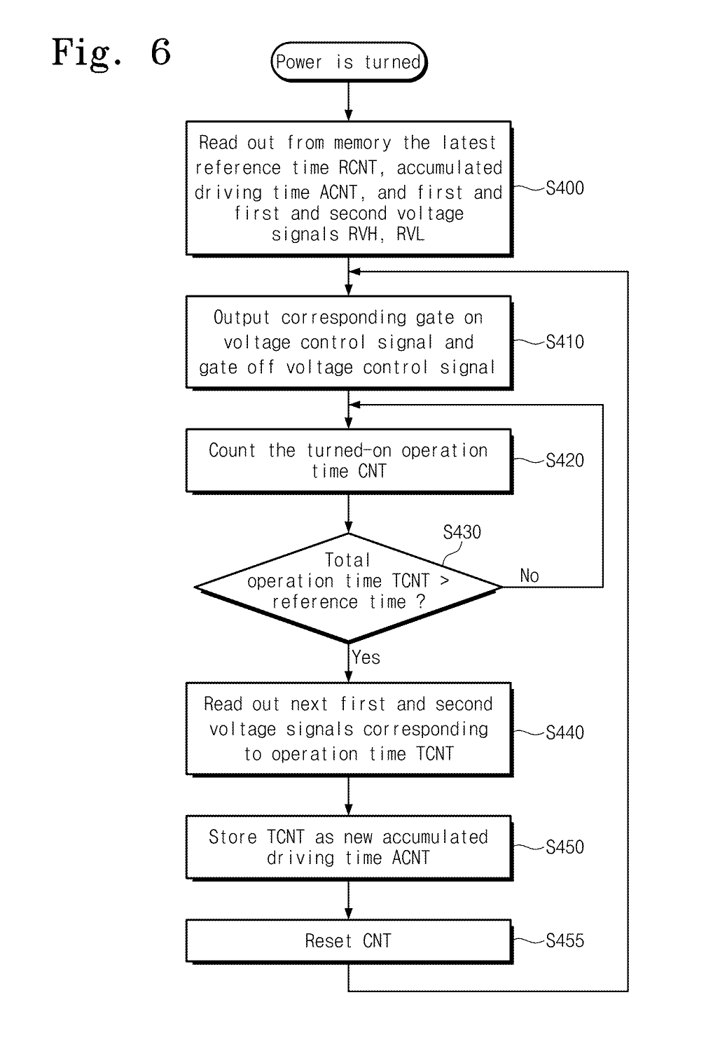

FIG. 6 is a flowchart showing a method of driving a display device according to an exemplary embodiment of the present disclosure. For the convenience of explanation, the method of driving the display device will be described with reference to the timing controller shown in FIG. 3, but it should not be limited thereto or thereby.

Referring to FIGS. 3 and 6, when the power is turned on, the count value CNT of the counter 210 of the timing controller 120 has been automatically reset to zero (0) --for example because in FIG. 3, the inverse of PowerOn is coupled to the counter RST terminal (not shown). In response to the power on event, the voltage control signal generator 220 reads out from the memory 230, the latest reference time RCNT value, the current accumulated driving time value ACNT, the corresponding first voltage signal RVH, and the corresponding second voltage signal RVL (step S400). For instance, as shown in FIG. 4 and Table 1, when the accumulated driving time ACNT is zero, the corresponding reference time RCNT is about 1000 hours, the corresponding first voltage signal RVH is about 22.5 volts, and the corresponding second voltage signal RVL is about −4 volts.

The voltage control signal generator 220 outputs the corresponding gate-on voltage control signal VH in response to the read-out first voltage signal RVH and the corresponding gate-off voltage control signal VL in response to the read-out second voltage signal RVL (S410). The voltage generator 310 then responsively generates the corresponding gate-on voltage VON of about 25 volts in response to the supplied gate-on voltage control signal VH.

The counter 210 (which now has enable EN terminal set high and is receiving VSYNK pulses at its CLK terminal—see FIG. 3) counts the number of elapsed frames and thus the corresponding period of operation based on the received vertical synchronization signal pulses VSYNC (S420). The counter 210 applies its incrementing count value CNT to the voltage control signal generator 220. The voltage control signal generator 220 adds the accumulated driving time ACNT read out from the memory 230 to the count value CNT from the counter 210 to thus calculate the total current operation time TCNT of the display device 100.

When the calculated total driving time TCNT exceeds the latest reference time RCNT read out from the memory 230 (S430), the voltage control signal generator 220 accesses the memory 230 and reads out from there the next of successive reference time values RCNT, and the corresponding first voltage signal RVH, and the corresponding second voltage signal RVL that are cross associated in the memory 230 with that RCNT value and with the calculated total driving time TCNT (S440). For instance, the newly read-out, next reference time RCNT may be about 2000 hours and the corresponding first voltage signal RVH is about 27.5 volts.

The voltage control signal generator 220 additionally accesses the memory 230 for writing into it (storing) the latest TCNT value which is the sum of the current count value CNT and the last-used accumulated driving time value ACNT(S450). After that, in step S455, the voltage control signal generator 220 sends a reset pulse (RST not shown) to the counter 210 to thereby reset the CNT value back to zero (0) and control is then passed to block S410 for continued execution. If the display device 100 is turned off and then later powered-on again, the voltage control signal generator 220 will read out the newest accumulated driving time value ACNT last stored into the memory 230. According to another embodiment, the display device 100 may be designed such that the total driving time TCNT is automatically is automatically stored in the memory 230 as the next ACNT value each time the display device 100 is powered-down.

Upon looping back to step S410 after executing step S455, the voltage control signal generator 220 outputs the corresponding gate on voltage control signal VH in response to the newly read-out first voltage signal RVH corresponding to the latest ACNT value and the corresponding gate off voltage control signal VL in response to the newly read-out second voltage signal RVL which also corresponds to the latest ACNT value (S410). As described above, the steps S410 to S455 are repeatedly performed while the display device 100 is in the operation state, and thus the voltage level of the gate on voltage VON and the gate off voltage VOFF may be controlled.

When the count value TCNT does not exceed the reference time RCNT read out from the memory 230 (S430), the voltage control signal generator 220 maintains the gate on voltage control signal VH and the gate off voltage control signal VL and monitors the count value CNT from the counter 210.

According to the above-mentioned method, although the voltage-current (Vgs-Ids) characteristic of the switching transistor of the pixel is changed due to the accumulated operation time of the display device 100, which is maintained for a long time, the display quality of the display device 100 may be prevented from degrading due to shifting of the Ids versus Vgs curve, which shifting is schematically diagramed in FIG. 2.

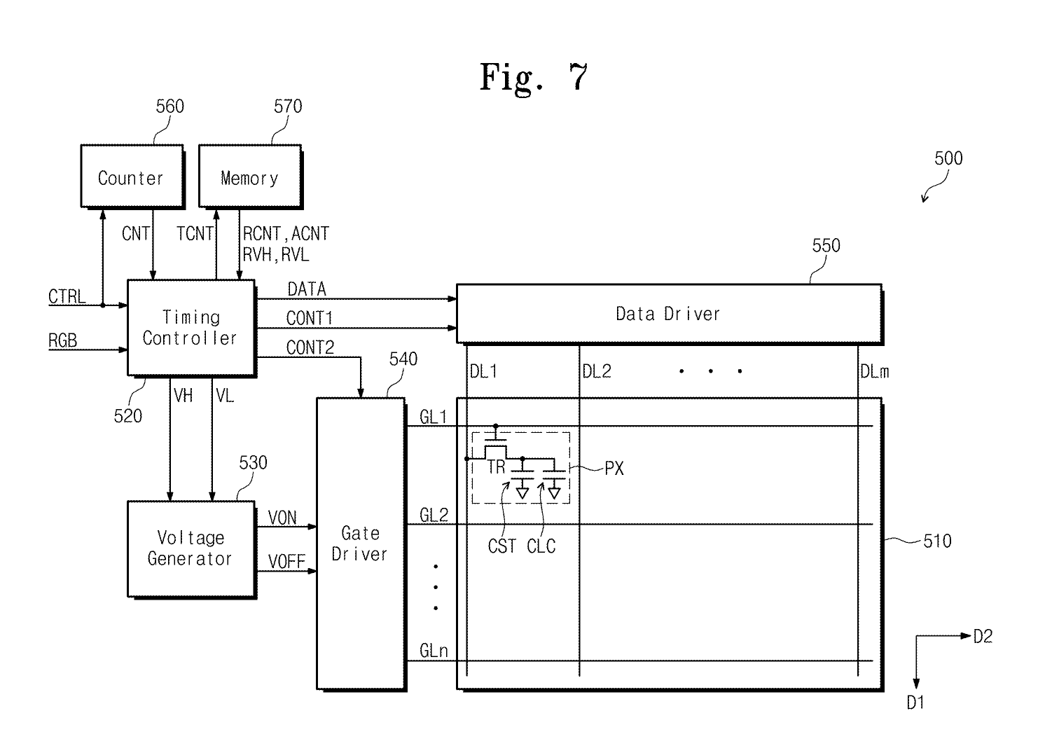

FIG. 7 is a block diagram showing a display device according to another exemplary embodiment of the present disclosure.

Referring to FIG. 7, a display device 500 includes a display panel 510, a timing controller 520, a voltage generator 530, a gate driver 540, a data driver 550, a counter 560, and a memory 570.

The operation of the display panel 510, the voltage generator 530, the gate driver 540, and the data driver 550 is substantially the same as that of the display panel 110, the voltage generator 130, the gate driver 140, and the data driver 150, and thus detailed descriptions of the display panel 510, the voltage generator 530, the gate driver 540, and the data driver 550 will be omitted.

The counter 560 receives control signals CTRL from an external device (not shown) to count the operation time of the display panel 510. As an example, the counter 560 receives the vertical synchronization signal VSYNC among the control signals CTRL and calculates the operation time of the display panel 510. That is, the counter 560 counts the number of frames using the vertical synchronization signal pulses VSYNC and outputs the corresponding count value CNT after power-up reset of the counter 560. In the present exemplary embodiment, although the counter 560 counts the period of the vertical synchronization signal VSYNC, but it should not be limited thereto or thereby. For instance, the counter 560 may count an operational on period using the horizontal synchronization signal pulses, the main clock signal pulses, or pulses of an RGB data enable signal. When the power is first turned on, an initial count value CNT output from the counter 560 may be set to zero (0). The controller 520 receives the image signals RGB and the control signals CTRL, such as, the vertical synchronization signal, the horizontal synchronization signal, the main clock signal, the data enable signal, etc., from the external device (not shown). The controller 520 processes the image signals RGB appropriate to the operation condition of the display panel 110 on the basis of the control signals CTRL to output the data signal DATA. The timing controller applies the data signal DATA and the first control signal CONT1 to the data driver 550 and applies the second control signal CONT2 to the gate driver 540.

The timing controller 520 outputs the gate on voltage control signal VH and the gate off voltage control signal VL in response to the sum of the count value CNT received from the counter 560 and the most current ACNT value received from the memory 570. The gate on voltage control signal VH and the gate off voltage control signal VL are applied to the voltage generator 530. The voltage generator 530 sets a voltage level of the gate on voltage VON in response to the gate on voltage control signal VH and a voltage level of the gate off voltage VOFF in response to the gate off voltage control signal VL.

When the count value CNT is zero while the power is being turned on, the timing controller 520 reads out the reference time RCNT, the accumulated driving time ACNT, the first voltage signal RVH, and the second voltage signal RVL from the memory 570, which correspond to the accumulated driving time ACNT.

The timing controller 520 outputs the gate on voltage control signal VH corresponding to the read-out first voltage signal RVH and the gate off voltage control signal VL corresponding to the read-out second voltage signal RVL.

The count value CNT of the counter 560 is increased while the display device 500 is in the operation state, i.e., while the vertical synchronization signal pulses VSYNC are input. The timing controller 520 adds the count value CNT and the accumulated driving time ACNT read out from the memory 570 to calculate the total driving time TCNT. The timing controller 520 compares the total driving time TCNT and the reference time RCNT read out from the memory 570. When the driving time TCNT does not exceed the reference time RCNT, the timing controller 520 maintains the gate on voltage control signal VH and the gate off voltage control signal VL.

When the driving time TCNT exceeds the reference time RCNT in accordance with the increase of the count value CNT, the timing controller 520 reads out from the memory 570 the next reference time RCNT, the corresponding first voltage signal RVH, and the corresponding second voltage signal RVL, which correspond to the latest total driving time TCNT. In addition, the timing controller 520 stores the driving time TCNT in the memory 570 as the new accumulated driving time ACNT.

The timing controller 520 outputs the gate on voltage control signal VH corresponding to the first voltage signal RVH read out from the memory 570 and the gate off voltage control signal VL corresponding to the second voltage signal RVL read out from the memory 570. The timing controller 520 repeatedly performs the comparing operation to compare the reference time RCNT and the driving time TCNT.

As described above, the timing controller 520 may change the voltage level of the gate on voltage VON and the gate off voltage VOFF in accordance with the operation time of the display device 500.

Although the exemplary embodiments of the present disclosure of invention have been described, it is understood that the present teachings should not be limited to these exemplary embodiments but various changes and modifications can be made by one ordinary skilled in the art in view of the foregoing that are within the spirit and scope of the present teachings.

What is claimed is:

1. A display device comprising:
a display panel which includes a plurality of gate lines, a plurality of data lines, and a plurality of pixel units each having at least one transistor that is connected to a corresponding gate line among the gate lines and a corresponding data line among the data lines;
a gate driver which is configured to drive the gate lines;
a data driver which is configured to drive the data lines;
a voltage generator which is configured to generate a first voltage level and a second voltage level used to drive the gate driver; and
a timing controller which is configured to receive an input image signal, to generate therefrom a data signal and to also generate first control signals that are applied to the data driver, and second control signals that are applied to the gate driver,
wherein the timing controller is further configured to calculate a total operation time (TCNT) of the display panel and to apply corresponding first and second voltage control signals to the voltage generator,
wherein the voltage generator is configured to respond to the received and respective first and second voltage control signals and to correspondingly set its first and second voltage levels accordingly, and
wherein the timing controller is yet further configured to change at least one of the first and second voltage control signals at least when the total operation time (TCNT) exceeds a predetermined reference time (RCNT).

2. The display device of claim 1, wherein the timing controller further comprises a memory storing a plurality of first reference values to be drawn from as being the reference time, storing an accumulated driving time (ACNT), storing a plurality of second reference values to be drawn from as being a current reference first voltage control signal and storing a plurality of third reference values to be drawn from as being a current reference second voltage control signal, the reference first and second voltage control signals corresponding respectively to the first and second voltage control signals output by the timing controller.

3. The display device of claim 2, wherein the timing controller is configured to read out from the memory, the predetermined reference time (RCNT), the accumulated driving time (ACNT), the reference first voltage signal (RVH), and the reference second voltage signal (RVL) at least when power is turned on for the display device.

4. The display device of claim 3, wherein the timing controller further comprises a counter to count a number of elapsed a synchronization pulses received an external device, and the total operation time (TCNT) corresponds to a sum of the accumulated driving time (ACNT) and a time corresponding to the count value (CNT) of the counter.

5. The display device of claim 4, wherein the timing controller is configured to read out from the memory, new reference first and second voltage control signals corresponding to the total operation time (TCNT) when the total operation time exceeds the predetermined reference time (RCNT), and to apply corresponding first and second voltage control signals respectively to the voltage generator. for controlling the first and second voltage level signals of the voltage generator.

6. The display device of claim 5, wherein the voltage generator generates the first voltage having the voltage level corresponding to the first voltage control signal and the second voltage level having the voltage level corresponding to the second voltage control signal.

7. The display device of claim 5, wherein the timing controller stores the operation time in the memory as the accumulated driving time when the total operation time exceeds the predetermined reference time.

8. The display device of claim 4, wherein the counter counts pulses of at least one of a vertical synchronization signal, a horizontal synchronization signal, an image data enable signal, and a main clock signal.

9. The display device of claim 1, further comprising:
a counter which counts pulses of a synchronization signal received from an external device; and
a memory which stores the reference time (RCNT), an accumulated driving time (ACNT), a reference first voltage signal (RVH) corresponding to the first voltage, and a reference second voltage signal (RVL) corresponding to the second voltage.

10. The display device of claim 9, wherein the timing controller reads out the reference time, the accumulated driving time, the first voltage signal, and the second voltage signal from the memory when a power of the device is turned on.

11. The display device of claim 10, wherein the total operation time (TCNT) corresponds to a sum of the accumulated driving time (ACNT) and a time corresponding to the count value (CNT) of the counter.

12. A method of driving a display device, comprising:
setting an initial voltage level of a gate on voltage and of a gate off voltage when an operating power is first applied after manufacture to the display device;
counting pulses of a supplied synchronization signal to thereby calculate an total operation time of the display device after its manufacture; and
changing a voltage level of at least one of the gate on voltage and of the gate off voltage when the total operation time (TCNT) exceeds a predetermined reference time (RCNT).

13. The method of claim 12, wherein the setting of the initial voltage level comprises:
reading out the reference time, an accumulated driving time, a first voltage signal, and a second voltage signal from a memory; and
outputting the gate on voltage having the voltage level corresponding to the first voltage signal and the gate off voltage having the voltage level corresponding to the second voltage signal.

14. The method of claim 13, wherein the total operation time (TCNT) corresponds to a sum of the accumulated driving time (ACNT) and a time corresponding to a count value (CNT) obtained by counting the pulses of the supplied synchronization signal.

15. The method of claim 14, wherein the changing of the voltage level of the gate on voltage and the gate off voltage comprises:
reading out new first and second voltage control signals corresponding to the total operation time from the memory when the total operation time exceeds the predetermined reference time;
outputting a gate on voltage control signal corresponding to the new first voltage control signal and a gate off voltage control signal corresponding to the new second voltage control signal; and
outputting the gate on voltage having the voltage level corresponding to the gate on voltage control signal and the gate off voltage having the voltage level corresponding to the gate off voltage control signal.

16. The method of claim 15, wherein the memory stores a plurality of reference times, a plurality of first voltage signals respectively corresponding to the reference times, and a plurality of second voltage signals respectively corresponding to the reference times.

17. The method of claim 16, further comprising;
storing the total operation time in the memory as a new accumulated driving time when the total operation time exceeds an old reference time; and
afterwards, reading out a new reference time corresponding to the total operation time from the memory.
